(19) United States
(12) Patent Application Publication
(10) Pub. No.: US 2003/0016367 A1
(43) Pub. Date: Jan. 23, 2003

(54) Device for quantitative assessment of the aligned position of two machine parts, workpieces or the like

(75) Inventors: Michael Hermann, Villingen (DE); Heinrich Lysen, Garching (DE)

Correspondence Address: NIXON PEABODY, LLP, 8180 GREENSBORO DRIVE, SUITE 800, MCLEAN, VA, 22102, US

(73) Assignee: Pruftechnik Dieter Busch AG, Ismaning (DE)

(21) Appl. No.: 10/253,698

(22) Filed: Sep. 25, 2002

Related U.S. Application Data
(63) Continuation-in-part of application No. 09/817,797, filed on Mar. 27, 2001.

(30) Foreign Application Priority Data
Sep. 25, 2001 (DE) 100 47 039.8

(51) Int. Cl. G01B 11/14

(52) U.S. Cl. 356/614

(57) ABSTRACT

A device for quantitative assessment of the aligned position of two machine parts, workpieces or the like is used especially for purposes of axis alignment or spindle alignment. A light beam is incident on an optoelectronic sensor which can be read out two-dimensionally and the impact point there is determined by the sensor. Part of the light beam is preferably reflected by the sensor directly onto a second optoelectronic sensor. The impact point of the reflected light beam there is determined in a feasible manner by the second sensor. The orientation of at least the first sensor relative the location of the light beam is determined from the signals of the two sensors.

### RELATED APPLICATION DATA

This application is a Continuation-in-Part of application Ser. No. 09/817,797, filed Mar. 27, 2001.

### BACKGROUND OF THE INVENTION

1. Field of the Invention

The invention relates to a process and pertinent devices for assessment of the aligned position of two machine parts, for example, shafts, machine tool spindles, workpieces or the like.

2. Description of Related Art

Processes of the generic type have been in use for years and are characterized by their application's saving much working time.

In addition to the processes and devices discussed in German Patent Application DE 3473344.2-08 and European Patent Publication EP 0183811, reference should also be made to the teachings of German Patent Publications DE 38 14 466 and DE 199 32 116.

In the latter two documents, it is described how the, aligned position of two machine parts, especially of two shafts which are to be connected to one another, or the alignment between a machine spindle and a workpiece, can be checked, measured and assessed using a single, beam-generating light source.

The devices and processes call for precision parts and components, which are cost-intensive optical components, and thus enable precise and reliable measurements. Since the advantages of the known systems are considerable, the relatively high production costs of the devices of this type are accepted by most potential users.

### SUMMARY OF THE INVENTION

An object of the invention is to improve the above processes in order to achieve a much lower production costs so that the devices can also be used in environments where, for reasons of expenses it was either not possible in the past or in any case was hesitatingly accepted.

This object is achieved through the use of a device, which makes the use of separate optical elements (reflectors, prisms, lenses) for the most part superfluous and thus leads to major cost savings.

According to an exemplary approach, the fact is used that the surface of position detectors, as are known from the cited application documents, in the current embodiment is of a very well suited, flat structure and thus actually cannot distinguish the additional function which is not provided, but still present, as a mirror with a defined reflectivity. Furthermore, the approach uses the fact that the energy load capacity of modem position detectors, especially in the form of CMOS sensors, has been greatly increased so that relatively high maximum intensity or radiation density on the sensor can be allowed. The use of this circumstance thus makes superfluous at least one optical precision component and its installation costs, for example calibration efforts, verification of operation, quality control in procurement, etc. For this reason a device can be made available which is characterized by clearly reduced component cost, can be more economically produced and thus can be used in many other applications, especially now also in the checking of the alignment of machine tools, their spindles or their tools.

Accordingly, the invention uses a device being made available for measuring or evaluating the relative position of two machine parts, tools or workpieces, which is characterized in that in combination there is a means for producing one or more masked light beams, an optoelectronic sensor of a first type and at least one optoelectronic sensor of a second type which can be read out two-dimensionally and are preferably pixel-oriented, wherein a relative alignment of two-dimensionally acting optoelectronic sensors of the first and the second type to one another, produces an incident masked light beam that is reflected by the surface of the optoelectronically active layer, or optionally by a specular layer of a pertinent cover glass, of the optoelectronic sensors of the first type proportionally and essentially directly in the form of a first and and optionally other light beams onto the optoelectronic sensor(s) of the second type (120), and an electronics or a computer which accepts the output signals delivered by the optoelectronic sensors, processes them, and computes the relative position of the means relative to the incident masked light beam.

### BRIEF DESCRIPTION OF THE DRAWINGS

FIG. 1 shows a known arrangement of sensors for ascertaining the relative position of the reference axis of an object with respect to a reference beam;

FIG. 2 shows another known arrangement for ascertaining the relative position of the reference axis of an object with respect to a reference beam, with a single, double-acting position sensor which can be read out two-dimensionally;

FIG. 3 shows an arrangement of sensors ascertaining the relative position of the reference axis of an object with respect to a reference beam for, for example, assessing the aligned position of two machine parts, tools, or workpieces;

FIG. 4 shows an exemplary arrangement of sensors and the incident light beam according to an embodiment of this invention;

FIG. 5 shows another arrangement according to an embodiment of this invention;

FIG. 6 shows an embodiment based on FIG. 4;

FIG. 7 shows one embodiment similar to FIG. 6, with another optical component; and

FIG. 8 illustrates the placement of one exemplary embodiment as on a machine coupling.

### DETAILED DESCRIPTION OF THE INVENTION

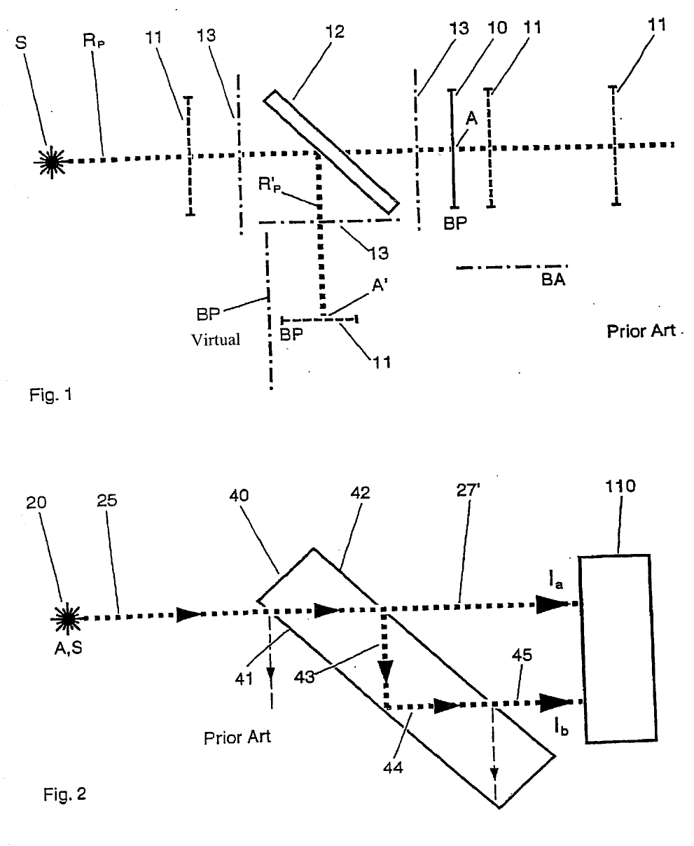

As shown in FIG. 1 and is known from the pertinent patent literature, a single light beam R and two optoelectronic position detectors which can be read out two dimensionally, A and A′, can be used to determine the relative reference axis of an object with respect to the light beam R. This can be used, for example, to very accurately determine the relative position of two shaft pieces, a machine tool spindle relative to a workpiece or the like. Typically several measurements are taken in order to obtain more accurate or reliable characteristic values using a set of measurement data, which values can also be subjected to subsequent data processing. It is important that the indicated arrangement can determine not only the parallel offset (according to two translational coordinates), but also the angular offset of the reference axis, and this according to two angle coordinates of space.

A similarly acting arrangement is shown in FIG. 2. The embodiment in FIG. 2, however, has two specular or partially specular surfaces. For this reason, instead of two separate sensors, there is now a single one which has a double-acting function. With this arrangement, the reference axis can be determined relative to an incident light beam according to a total of four coordinates, specifically two translational coordinates and two angular coordinates. It can be understood that high demands must be imposed on the precision of the multiple reflectors 40 shown.

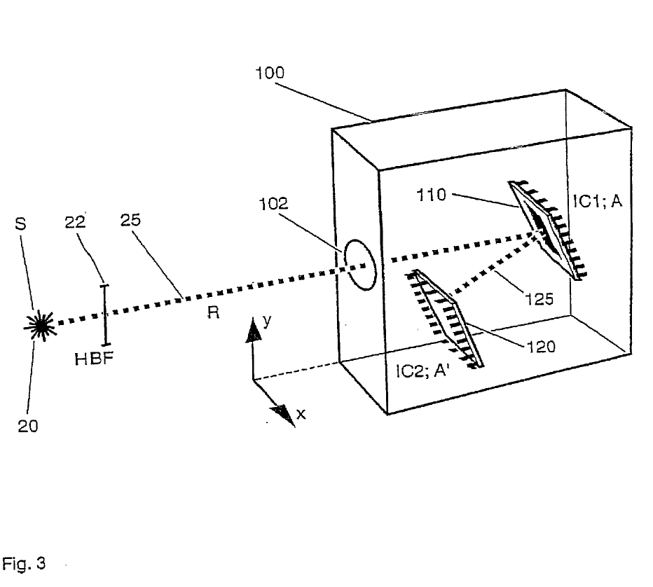

As shown in FIG. 3, it is now also possible to eliminate the multiple reflector 40 which is shown in FIG. 2 or the semi-transparent mirror 12 which is shown in FIG. 1. This takes place by the two-dimensionally sensitive optoelectronic sensor 110 (IC1; A) which can be read out being allowed to receive the impact point of a light beam R, reference number 25, not only with its light-sensitive layer in the conventional manner, but moreover, with its very flat surface being used to reflect a portion of the incident light beam 25. This portion is, depending on the surface quality, roughly 2 to 10% of the incident light and, at the current quality of the detectors used, is sufficient to adequately and effectively illuminate a second optoelectronic sensor 120 (IC2, A′). Therefore, the latter can execute further position determination of the incident light beam, as is necessary in the known approach. The optoelectronic sensors 110, 120 are made available as CMOS sensor circuits (ICs) which are irradiation-insensitive, but moreover highly sensitive and highly dynamic. A preferred IC component is of the type HCDS-2000 from HP/Agilent, with a diagonal of the sensitive surface of roughly 8 mm. If a surface of the optoelectronic sensors with larger dimensions is necessary, those as are used in current so-called digital cameras can be chosen. These modules are characterized by higher relative resolution, but are more expensive than the surprisingly economical components identified above.

As follows from FIG. 3, a laser light source S20, can emit a laser beam 25 which can pass through a very economical holographic beam former (HBF) 25 to improve beam quality. The laser light source 20 is typically located in a separate housing and is preferably connected to a first machine part. The optical sensors 110, 120 are advantageously located in a stationary housing 100 which is preferably connected to the second machine part. The laser beam 25 however enters the housing 100 through an aperture, for example a protective glass or film 102, and can act directly on the optical sensor 110.

The signals delivered by the optoelectronic sensors can be further processed in the conventional manner by means of a suitable computer and the pertinent software; this will not be explained in particular here for the sake of brevity (c.f. FIG. 8). The advantage known from FIG. 2, i.e., the ability to display the position and the intensity ratios of the laser beams incident on the optoelectronic sensors directly via the display of a portable computer, can also be perceived in this invention. It goes without saying that within the framework of the further computer processing of the signals acquired by the sensors, aspects of remote interrogation and so-called “networking” can be also treated and resolved.

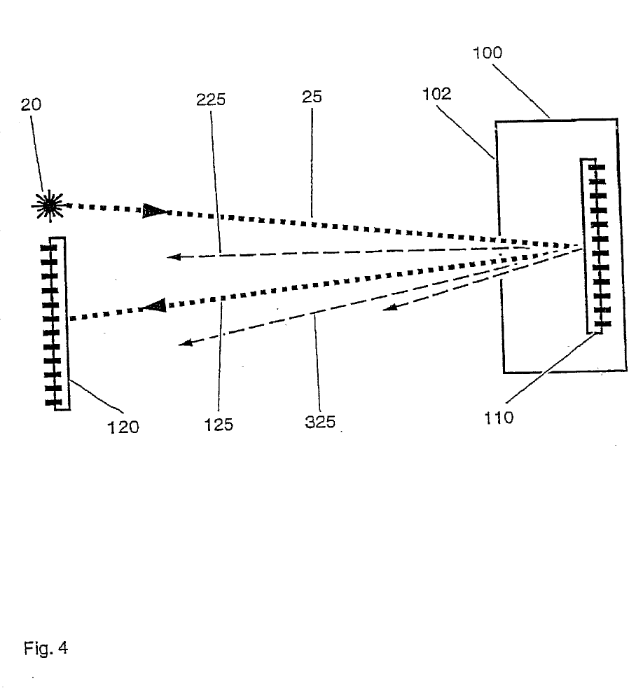

The other embodiment of the invention shown in FIG. 4 increases the attainable angular resolution. This embodiment is preferred when the angular deviations to be studied are in the range of angular minutes. This is always the case when especially high demands are imposed on the parallelism of the machine parts to be aligned. The desired greater angular resolution is achieved by the relative remote arrangement of the optoelectronic sensor 120 with respect to the sensor 110 without the resolution being reduced with respect to the parallel displacements (offset). The aperture 102 can be made in the case of the embodiment as shown in FIG. 4 as a partially transmitting mirror. However, this dictates additional costs and is an obstacle to the desired, most economical solution; but, the advantage arises that the intensity of the received light beams is roughly the same on both optoelectronic sensors.

As shown in FIG. 4, it is also possible to use the properties of a pixel-oriented sensor which are diffractive in reflection (diffraction on two-dimensional gratings of the pixels) when one such sensor is being used. Accordingly, in addition to the light beam 125 which is reflected in a so-called zeroth order of diffraction, also the simultaneously arising secondary beams 225, 325, etc. of the 1st, 2nd, 3rd etc. order of diffraction are imaged and evaluated either likewise on the sensor 120, or on one or more such sensors which are not shown in FIG. 4 for reasons of clarity. The principle shown in FIG. 4, i.e., to use several reflected beams (125, 225, 325) for measuring the relative orientation of the sensors and thus of the means 100 relative to the sensor 120, can feasibly be used in an arrangement as shown in FIG. 3.

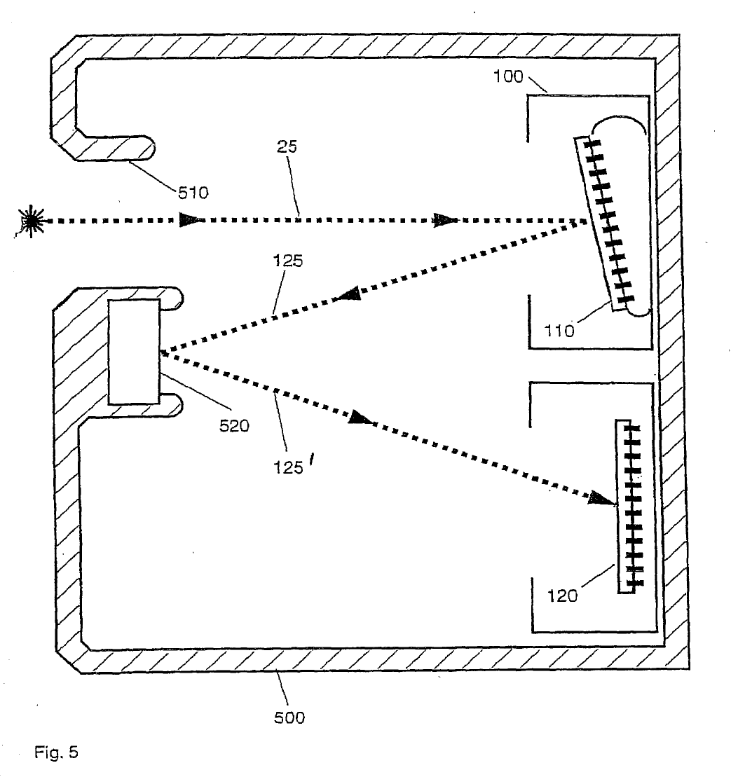

FIG. 5 shows one modification of the construction shown in FIG. 4. Here, the beam 125 is folded by means of a reflector 520 so that a shortened structural shape is available for the desired high angular resolution. In addition, the sensors 110, 120 are in the spatial vicinity so that questions of cabling in this respect and signal transmission can be simplified. If necessary, the sensors 118, 120 can even be monolithically combined. As follows from FIG. 5, within a surrounding housing 500, on its back there are sensors 110, 120. The sensor 110 is mounted roughly angled. A light beam 25 which is incident in the surrounding housing through the opening 510 is thus reflected by the proportionably reflecting surface of the sensor 110 onto the reflector 520 in order to travel from there as the beam 125′ to the sensor 120. This sensor arrangement is thus suitable for determining an incident light beam with respect to its relative position with reference to the dimensions of the housing 500 according to two translational coordinates. Furthermore, this sensor arrangement is likewise suited for determining the direction of the incident light beam according to two angular coordinates relative to the axis of symmetry of the housing 500, only one additional optical element in the form of a reflector is necessary. If, in addition, there is a beam 25 of asymmetrical cross sectional shape, the rotational position (“roll” coordinate) of the housing 500 is possible relative to one axis of rotation which is defined by the light beam.

In one modification of the invention, optoelectronic sensors of varied technology can also be used so that, for example, the sensor 100 is pixel-oriented and the sensors of the second type (12) can determine only the centroidal location of an incident family of light beams.

The invention in the embodiment as shown in FIG. 5 is specially suited for use as an optical receiving unit for the position detection system as illustrated in German Patent Publication DE 19733919 and U.S. Pat. No. 6,049,378.

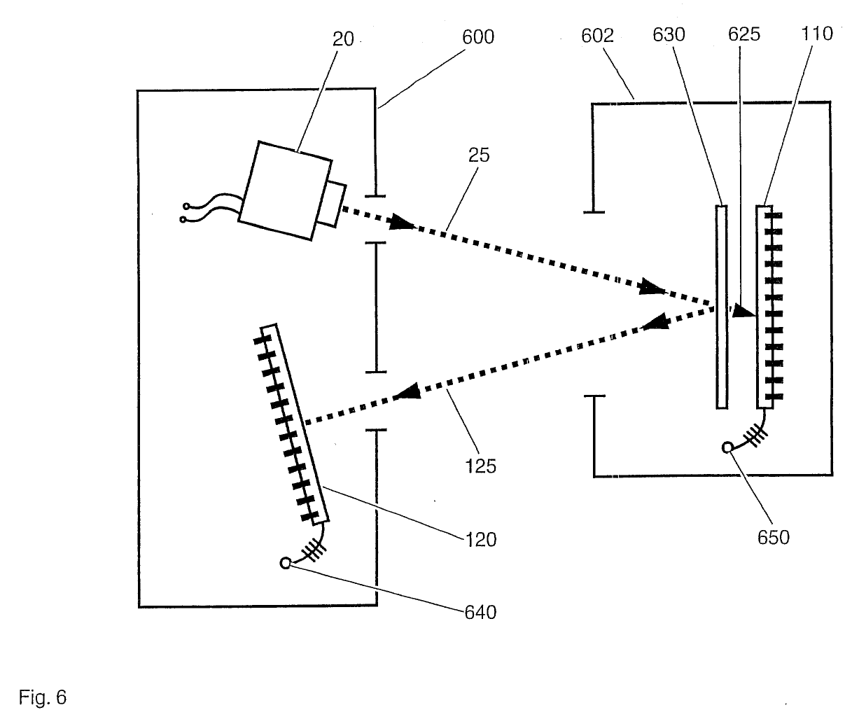

FIG. 6 shows the aforementioned modification of the embodiment as shown in FIG. 4. The laser beam 25 which is emitted, for example, from a laser light source 20 is reflected by a partially transparent mirror 630 on the one hand proportionally as a partial beam 125, on the other hand it strikes the sensor 110 as a partial beam 625 and can be recorded there. If it is desirable to protect the sensor 110 against outside light, it can have absorbing or filtering properties.

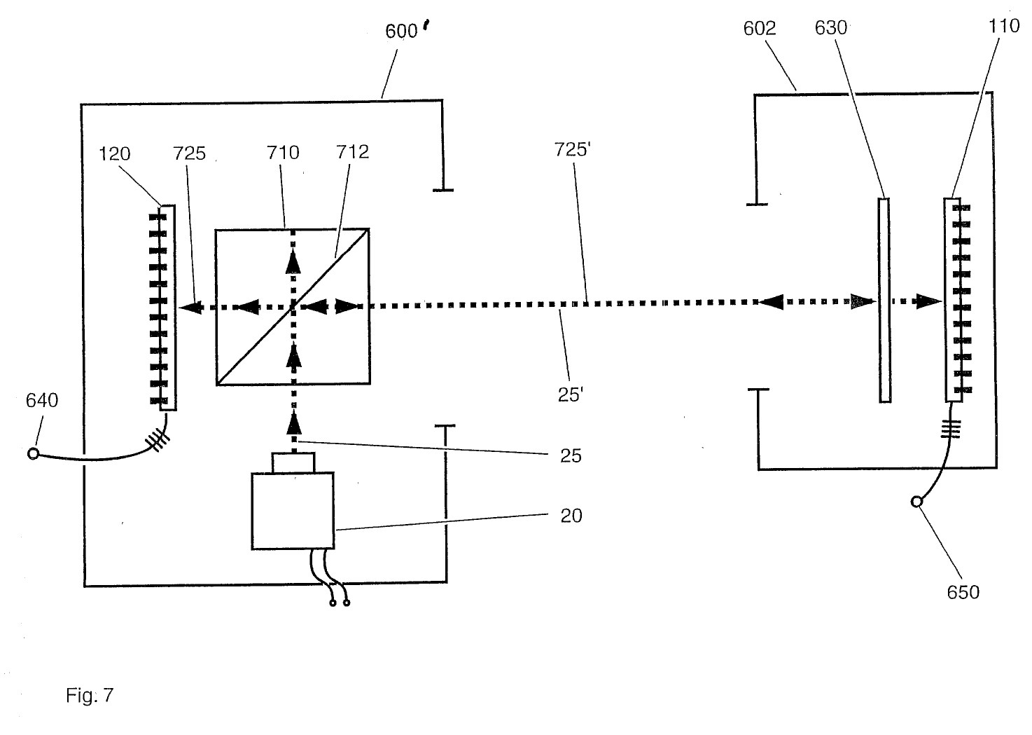

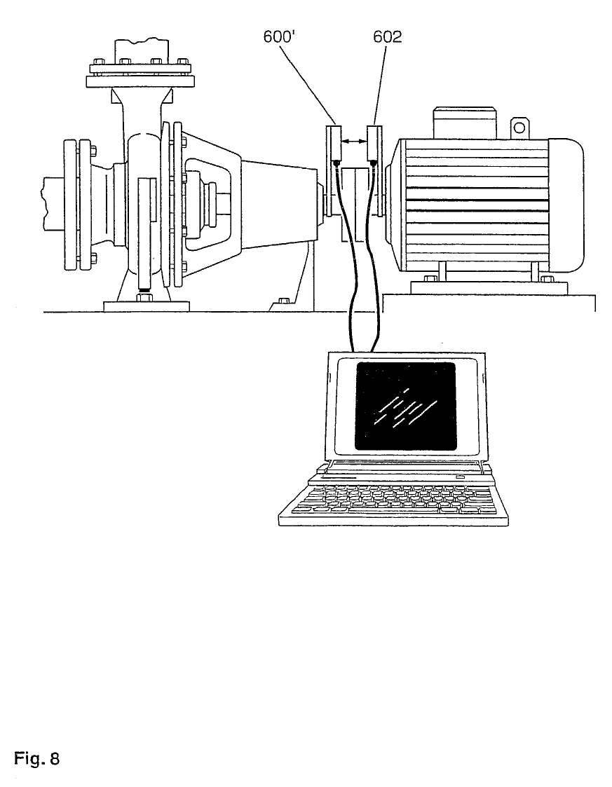

A comparable beam path is shown in FIG. 7. In addition to the partially transparent mirror 630, there is in addition a beam splitter 710 with partially reflecting properties. The beam splitter 710, the laser light source 20 and the sensor 120 are located in a common housing 600′ and are spaced a fixed amount apart. The common housing 600′ has an aperture through which laser light can pass. The laser beam 25 emitted by the laser light source 20 is therefore proportionally deflected by the partially reflecting beam splitter surface 712 first in the direction of the sensor 110 (the passing portion is delivered to a beam absorber). As described above, one part of this deflected beam reaches the partially transparent mirror 630 and is proportionally passed onto the sensor 110. On the other hand, part of the deflected beam is reflected back by the partially transparent 630 in the direction of the beam splitter 710. Part of this reflected-back beam can pass through the beam splitter 710 and is incident as a laser beam 723 on the sensor 120. The embodiment as shown in FIG. 7 is therefore less sensitive to changes in the distance of the sensors 110 and 120 from one another. Even if the embodiment as shown in FIG. 7 due to the beam splitter 710 and the partially reflecting mirror 630 can be labelled more complex compared to the embodiment as shown in FIG. 4, it is incident under the measurement principle of the present invention which acts with only a single laser light source (20) and two assigned sensors (110, 120). The housings 600′, 602, which are assigned to the sensors 110 or 120. are mounted on the shafts, axles or the like to be aligned by means of holders according to the prior art. The displacement of the sensors and the evaluation of the obtained measurement results also take place according to the procedures as are known from the prior art and which will not be repeated here, for the sake of brevity.

The embodiment shown can be made so economical and requires so little electricity that it can optionally be installed permanently on rotating shafts. For this purpose it is advantageous to provide a energy supply which works without contact and signal decoupling for the electronic components used.

What is claimed is:

1. Device for measuring or evaluating the relative position of two elements with respect to each other, comprising:
a light source for producing at least one masked light beam;
a first two-dimensionally readable optoelectronic sensor and at least one second two-dimensionally readable optoelectronic sensor which are in a relative alignment with respect to each other such that a masked light beam incident on a surface of an optoelectronically active layer of the first optoelectronic sensor is reflected by the surface proportionally and essentially directly as a light beam onto a surface of the at least one second two-dimensionally readable optoelectronic sensor;
electronic means for receiving output signals from the optoelectronic sensors, processing the signals, and computing the relative position of the electronic means relative to the incidences of the at least one masked light beam on the surfaces of the two-dimensionally readable optoelectronic sensors.

2. Device for measuring or evaluating the relative position of two elements with respect to each other, comprising:
a light source for producing at least one masked light beam along a beam path;
a first two-dimensionally readable optoelectronic sensor and a second two-dimensionally readable optoelectronic sensor;
a partially transmitting mirror which is located in the beam path in front of the first optoelectronic sensor which can be read out two-dimensionally, the mirror and the sensors being in a relative alignment with respect to each other such that a masked light beam incident on a surface of an optoelectronically active layer of the first optoelectronic sensor is reflected by the mirror proportionally and essentially directly as a light beam onto a surface of the second two-dimensionally readable optoelectronic sensor;
electronic means for receiving output signals from the optoelectronic sensors, processing the signals, and computing the relative position of the at least one masked light beam relative to the first two-dimensionally readable optoelectronic sensor.

3. Device for measuring or evaluating the relative position of two elements with respect to each other, comprising:
a light source for producing at least one masked light beam;
a first two-dimensionally readable optoelectronic sensor and at least one second two-dimensionally readable optoelectronic sensor;
a housing in which the first and second two-dimensionally acting optoelectronic sensors are positioned relative to one another such that an masked light beam incident on the first two-dimensionally readable optoelectronic sensor is proportionally reflected as a plurality of light beams in a folded beam path by a surface of an optoelectronically active layer of the first optoelectronic sensor onto the second two-dimensionally acting optoelectronic sensor; and
electronic means for receiving output signals from the optoelectronic sensors, processing the signals, and computing the relative position of the housing relative to the incidences of the at least one masked light beam on the surface of the at least one second two-dimensionally readable optoelectronic sensors.

4. Device for measuring or evaluating the relative position of two machine parts, tools or workpieces, comprising:
a light source for producing at least one masked light beam;
first two-dimensionally acting sensor having an optoelectronically active layer and a second two-dimensionally acting optoelectronic sensor, said sensors being adapted to produce two-dimensional outputs;
a reflector between the first and second two-dimensionally acting optoelectronic sensors;
a housing within which the reflector and the first and second two-dimensionally acting optoelectronic sensors are mounted in an alignment relative to one another such that an incident masked light beam is proportionally reflected by a surface of the optoelectronically active layer of the first optoelectronic sensor to the reflector, and in a folded beam path, onto the second optoelectronic sensor; and
an electronic device connected to receive output signals from the optoelectronic sensors, said electronic device being adapted to process the output signals and compute the relative position of the housing relative to the incident masked light beam.

5. Device for measuring or evaluating the relative position of two machine parts, tools or workpieces, comprising:
a light source for producing at least one masked light beam;
first two-dimensionally acting sensor having an optoelectronically active layer and a second two-dimensionally acting optoelectronic sensor, said sensors being adapted to produce two-dimensional outputs;
a partially reflective mirror between the first and second two-dimensionally acting optoelectronic sensors;
a first housing within which the partially reflective mirror and the first two-dimensionally acting optoelectronic sensor are mounted;
a second housing within which the light source and the second two-dimensionally acting optoelectronic sensor are mounted; and
an electronic device connected to receive output signals from the optoelectronic sensors, said electronic device being adapted to process the output signals and compute the relative position of the housings;
wherein the first and second two-dimensionally acting optoelectronic sensors are mounted in an alignment relative to one another such that a portion of the incident masked light beam is passed through the partially reflective mirror to the first optoelectronic sensor, and a portion of the incident masked light beam is reflected by the partially reflective mirror, in a folded beam path, onto the second optoelectronic sensor.

6. Device for measuring or evaluating the relative position of two machine parts, tools or workpieces, comprising:
a light source for producing at least one masked light beam;
first and second two-dimensionally acting optoelectronic sensors which produce two-dimensional outputs;
a first partially transparent mirror or beam splitter which is located in a beam path of the light beam and in front of the first optoelectronic sensor;
a second partially transparent mirror or beam splitter which is located in the beam path in front of the second optoelectronic sensor.
a housing in which said light source, said first two-dimensionally acting optoelectronic sensor and said first partially transparent mirror or beam splitter are located; and
an electronic device which is connected to receive output signals from the optoelectronic sensors, the electronic device being adapted to process the output signals and compute the relative position of the housing relative to a point of incidence of the masked light beam on the second two-dimensionally acting optoelectronic sensor;
wherein the two-dimensionally acting optoelectronic sensors and the partially transparent mirror or beam splitters are mounted and aligned relative to one another such that an incident light beam is proportionally directed by the first partially transparent mirror or beam splitter as a light beam both onto the first two-dimensionally acting optoelectronic sensor, and after passing through the second partially transparent mirror or beam splitter, onto the second two-dimensionally acting optoelectronic sensor.
